(19) United States
(12) Patent Application Publication
(10) Pub. No.: US 2008/0120793 A1
(43) Pub. Date: May 29, 2008

(54) Method of Leather Processing and Leather of Three-Dimensional Shape

(76) Inventor: Hideki Tomiyama, Kyoto (JP)

Correspondence Address: KRATZ, QUINTOS & HANSON, LLP, 1420 K Street, N.W., Suite 400, WASHINGTON, DC, 20005, US

(21) Appl. No.: 11/883,378

(22) PCT Filed: Feb. 1, 2006
(86) PCT No.: PCT/JP2006/301681

§ 371 Date: Jul. 31, 2007

(30) Foreign Application Priority Data
Feb. 2, 2005 (JP) 2005-026330

(51) Int. Cl. D05B 15/00; C14B 99/00; D06P 3/32

(52) U.S. Cl. 8/436; 112/475.08; 69/21

(57) ABSTRACT

A method of leather processing which, without need of using a large amount of a hardener, etc., can yield a leather which can retain a three-dimensional shape, especially one with a fine, highly attractive design, for a long time and has high stretchability and high recovery while retaining the flexibility inherent in leathers; and a leather of a three-dimensional shape, especially a processed leather of a pattern and shape such as ones formed by wringing the leather together. The method comprises deforming a flat leather into a three-dimensional shape having recesses and protrusions and heating at least part of either or both of the protrusions (2) and recesses (1) to cure the heated parts and thereby cause the leather to retain the three-dimensional shape. More specifically, the protrusions and the recesses are partly heated while keeping the remaining parts being insulated from the heat to cure the heated parts only.

### FIELD OF THE INVENTION

The present invention relates to a desirable method of leather processing to cause the leather to retain a three-dimensional shape, and the leather of a three-dimensional shape.

### BACKGROUND ART

A variety of techniques to cause leather to retain a three-dimensional shape have been so far applied in consideration to properties peculiar to the leather.

One example of such techniques is an embossing method wherein dies having protrusions and recesses are used to give leather a three-dimensional shape. More specifically, a desirable three-dimensional shape is first designed, and male and female dies having protrusions and recesses conformed to said design are produced. Then, leather is clamped between said male and female dies so that the whole leather is embossed by applying pressure on the dies. The leather is thereby deformed as per the protrusions and recesses of the dies to retain a three-dimensional shape (Refer to the Patent document 1).

There is also a crush processing method that can simply give leather a three-dimensional shape without the need of said dies, etc., wherein leather is shrunk under high pressure so that the whole leather can be purposely crimpled.

However, the whole leather is deformed only by the pressure in said method and thus, its protrusions and recesses will disappear with an elapse of time and it may not keep its original state of three-dimensional shape for a long time.

A cover for sofas or the like in particular is often subject to friction with sitters and it will lose its three-dimensional shape in an earlier stage. As a result, a free optionability of products that can make use of the leather in question will be extremely limited.

Moreover, the leather will be apt to be deteriorated, because the whole leather is pressurized when it receives a three-dimensional processing.

In the case of the embossing method, dies have to be prepared as per the design, and it causes the manufacturing process to be complicated, in addition to an increase of manufacturing costs. In conventional methods, a three-dimensional shape of leather has been fixed by applying a hardener to the leather, and as the whole face of the leather is cured in that case the leather obtained has less stretchability, causing a freely selectable scope of availability of products that can make use of the leather in question to be limited.

On the other hand, it is true that dies are not required in the crush processing method but it is not possible to provide protrusions and recesses as exactly as a designer's intention so that products, for example, boasting a certain motif of highly attractive designs may not be obtained.

In addition, products like a glove or the like have to be made of materials having high stretchability and thus, leather had to be conventionally used as a composite material with a cloth or the like whenever it is utilized.

[Patent Document 1] Japanese Unexamined Patent Application Publication No. HEI 7-138600

### DISCLOSURE OF THE INVENTION

### Problems to Be Solved by the Invention

Therefore, it is an object of the present invention to provide a method of leather processing which, without the need of using a large amount of a hardener, etc., can yield a leather which can retain a three-dimensional shape, especially one with a fine, highly attractive design, for a long time and has high stretchability and high recovery while retaining the flexibility inherent in leathers, and a leather of a three-dimensional shape, especially a processed leather of a three-dimensional pattern formed by wringing the leather together by applying a leather to tying processing method.

### Means to Solve the Problems

To solve the problems as mentioned above, the present invention provides a method of leather processing comprising the steps of deforming a flat leather into a three-dimensional shape having protrusions and recesses and heating at least a part of either or both of said protrusions and recesses to cure the heated parts and thereby cause the leather to retain the three-dimensional shape. The protrusions and recesses mean parts having protruding and recessed shapes wherein the parts are formed by bending or folding leather, and the parts protruding from the surface are called protrusions and those protruding from the back side are called recesses.

It's preferable that the method of leather processing comprises a step of insulating the remaining parts exclusive of the heated parts of said protrusions and recesses. Insulation here means preventing the heat applied to leather at least in the heating step from transferring to the leather so that it cannot cure the leather. It includes, for example, covering (or sealing) the leather for avoiding its contact with a heating fluid etc., or positively cooling the leather by letting it approach or contact a cooling device in which a cooling medium such as cooling water etc. flows through.

It is also preferable that a linear sewing and wringing member such as a thread or a string is put into a flat leather to wring the leather together so as to bring the leather into a state where a plurality of mountain-like protrusions having a length lie in succession, thereby deforming the leather into a three-dimensional shape having said protrusions and recesses. Wringing here means fixing the leather in a state that the leather is wrung by using a sewing and wringing member. More specifically, wringing in the present invention means wringing the leather containing sewing and wringing members (threads etc.) therein together along said threads and fixing the threads coming out of the leather so as to prevent the wrung leather from extending out, including alternative examples; protrusions are softly wrung so that they are somewhat apart from each other, or protrusions are closely positioned.

It is preferable that said sewing and wringing member is put through said protrusions at both ends of their lengthwise directions, at neighborhood of both ends of their lengthwise directions, at both ends of their lengthwise directions and the intermediary portions thereof, or neighborhood of both ends of their lengthwise directions and the intermediary portions thereof. More specifically, it is preferred to put said sewing and wringing member through said protrusions at an upper position rather than the intermediary position of their protruding height directions.

Moreover, it is preferred to wring the leather together so as to bring it into a state where a plurality of mountain-like protrusions having a length lie in succession, to thereby overlap side wall portions between the protrusions and recesses each other in order to decrease heat conduction from the outside to said wall portions or to bring them into an insulating state so as to prevent a heated fluid from soaking (infiltrating) into them.

It is a preferable processing method in which either of said protrusions or recesses are insulated by externally fitting an insulating material closely onto them while the other protrusions or recesses are heat-cured by a heating means.

It is preferred to use a heater as said heating means or to use a heating fluid in which at least heated portions are soaked.

More specifically, it is a preferable method of leather processing, wherein a linear sewing and wringing member such as a thread, a string etc. is put into a flat leather to wring the leather together so as to bring it into a state where a plurality of mountain-like protrusions having a length lie in succession, thereby deforming it into a three-dimensional shape having said protrusions and recesses, and overlapping side wall portions between the protrusions and recesses each other in order to bring them into an insulating state, and soaking the whole leather in a heating fluid to cure the protrusions and recesses to thereby retain a three-dimensional shape by said curing.

It is a preferable method of leather processing, wherein a linear sewing and wringing member such as a thread, a string etc. is put into a flat leather to wring the leather together so as to bring the leather into a state where a plurality of mountain-like protrusions having a length lie in succession, thereby deforming it into a three-dimensional shape having said protrusions and recesses, overlapping side wall portions between the protrusions and recesses each other in order to bring them into an insulating state, insulating either of said protrusions or recesses by externally fitting an insulating material closely onto them, soaking the whole leather in a heating fluid to cure the other of said protrusions or recesses, and causing the leather to retain a three-dimensional shape by said curing.

When dyeing the leather is required, it is preferred to use a dye liquor at a given temperature as the said heating fluid.

It is a preferable embodiment in which synthetic resin or synthetic resin compound is attached to the outer surface of the leather retaining the three-dimensional shape by application, scattering, immersion etc.

The present invention also provides a leather of a three-dimensional shape characterized in that the three-dimensional shape is retained by deforming a flat leather into a three-dimensional shape having protrusions and recesses, heating at least a part of either or both of said protrusions or recesses to cure the heated parts, and causing the leather to retain a three-dimensional shape by said curing.

Then, it can be selected a leather formed by insulating the remaining parts exclusive of the parts to be heated of said protrusions and recesses to cure said heated parts only.

It is a preferable leather of a three-dimensional shape characterized in that the three-dimensional shape is retained by putting a linear sewing and wringing member such as a thread or a string into a flat leather to wring the leather together so as to bring the leather into a state where a plurality of mountain-like protrusions having a length lie in succession to thereby deform the leather into a three-dimensional shape having protrusions and recesses, while overlapping side wall portions between the protrusions and recesses in order to bring them into an insulating state, soaking the whole leather in a heating fluid to cure the protrusions and recesses, and retaining a three-dimensional shape by said curing.

It is a preferable leather of a three-dimensional shape characterized in that the three-dimensional shape is retained by putting a linear sewing and wringing member such as a thread or a string into a flat leather to wring the leather together so as to bring the leather into a state where a plurality of mountain-like protrusions having a length lie in succession to thereby deform the leather into a three-dimensional shape having protrusions and recesses, and overlapping side wall portions between the protrusions and recesses in order to bring them into an insulating state, insulating either of said protrusions or recesses by externally fitting an insulating material closely onto them, soaking the whole leather in a heating fluid to cure the other of said protrusions or recesses, and causing the leather to retain a three-dimensional shape by said curing.

It is preferred that ridge lines of respective protrusions of the leather are arranged parallel to each other, and such a leather may be selected as the lengths of ridge lines of respective protrusions and their positions in the lengthwise direction are random to each other in a plane view.

In the leather where a plurality paris of protrusions of which ridge lines are arranged in a nearly [symbol] -shaped character or a nearly V-shaped character in a plane view are provided in a given distance laterally and longitudinally, a three-dimensional shape composed of irregular protrusions with wringing pattern changes in a plane view caused by the leather extended are arranged, and said protrusions are given a supporting strength (tenacity) being capable of retaining their three-dimensional shape when pressure is applied from the surface.

### Effect of the Invention

According to the present invention as mentioned above, it is possible to remarkably enhance the retaining period of a three-dimensional shape of the leather, because its three-dimensional shape, wringing patterns and shapes in particular, are given to the leather by heat-curing and retained. It is superior in abrasion resistance of the three-dimensional shape and it can be preferably applicable for products such as sofas etc. to be often touched by users, and thus, a degree of free selectability of usage may be heightened.

Contrary to conventional products, it is not necessary to apply high pressure onto the whole face of leather and thus, it will be hard to be deteriorated, enhancing the durability of products made of the leather according to the present invention. It does not require any chemicals in its three-dimensional processing at all and thus, no adverse effects against environment are exerted not only in the processing stage of the leather but also in the disposing stage thereof.

The method of the present invention provides a process in which the remaining portions exclusive of said protrusions and recesses to be heated are insulated from the heat and thus, said insulated portions keep the flexibility inherent in leathers and the leather after processing is rich in stretchability, offering a stretch material boasting high recovery of a three-dimensional shape. Accordingly, it is possible to make a design of products requiring stretchability such as gloves etc. by the leather only, and a scope of design selectability for products using the leather may be remarkably extended to offer a variety of applications.

As per the steps of putting a linear sewing and wringing member such as a thread, a string etc. into a flat leather to wring the leather together so as to bring it to a state where a plurality of mountain-like protrusions having a length lie in succession, the leather can be deformed into a three-dimensional shape having said protrusions and recesses, and the side wall portions between the protrusions and recesses overlap each other to be insulated from the heat so as to keep them from being cured by the heat and thus, the flexibility of the leather can be retained. In addition, the deformation of the leather into a three-dimensional shape and the insulation of the side wall portions can be simultaneously performed and thus, the working process can be simplified. No pressure is applied to the leather in the deformation into a three-dimensional shape and thus, the deterioration of the leather can be avoided. Through carrying out the wringing by putting a linear sewing and wringing member such as a thread, a string etc. into a flat leather, a three-dimensional shape of the leather boasting a fine, attractive design can be obtained.

The sewing and wringing member is put through protrusions at both ends of their lengthwise directions or neighborhood thereof, more preferably at both ends of their lengthwise directions or neighborhood and intermediary portions thereof and thus, the protrusions are firmly built up in the wringing.

A plurality of stitch distances are applied to wring the leather together and thus, it is possible to clearly make the shape of protrusions and recesses. Especially said sewing and wringing member is put through the protrusions at an upper position rather than the intermediary position of their protruding height directions and thus, the protrusions overlap each other more securely to decrease their exposed area.

The side wall portions between said protrusions and recesses overlap each other to be insulated from the heat by wringing the leather together to bring it into a state where a plurality of mountain-like protrusions having a length lie in succession and thus, the side wall portions retain the flexibility inherent in leathers while the protrusions and recesses obtain a superior stretchability.

Either of said protrusions and recesses are insulated externally by closely fitting an insulating material to it and others are heat-cured by a heating means and thus, it is possible to cure either one only and to enhance the flexibility of the whole leather by the non cured portion of the other.

A heater is used as a heating means and thus, heat-curing of the leather can be easily conducted.

A heating fluid is used as a heating means for soaking at least heated portion of the leather and thus, heat-curing of the leather can be conducted more securely and at a proper temperature.

A dye liquor of given temperature is used as a heating fluid and thus, it is possible to conduct the dying and three-dimensional processes at the same time and achieve a simplified working process.

Resin or resin composition is deposited on the outer face of the leather which retains its three-dimensional shape by curing and thus, it is possible to enhance the shape retention of the leather.

Ridge lines of respective protrusions are arranged parallel to each other and thus, it is possible to easily overlap the protrusions and conduct securely the insulation of the side wall portions or the like.

An ideal nature-like shape of protrusions and recesses can be obtained by setting the lengths of ridge lines of respective protrusions and their positions in the lengthwise direction at random to each other in a plane view, and an attractive pattern of a three-dimensional shape can be obtained by setting ridge lines arranged in a nearly [symbol] -shaped character or a nearly V-shaped character in a plane view, and by providing a plurality of protrusions giving a supporting strength to the leather in a given distance laterally and longitudinally.

### BRIEF DESCRIPTION OF THE DRAWINGS

FIG. 1 A perspective view showing a leather of a three-dimensional shape as a representative embodiment of the present invention.

FIG. 2 A plan view showing said leather of a three-dimensional shape.

FIG. 3 A sectional view showing said leather of a three-dimensional shape.

FIG. 4 A flow diagram showing the steps of the processing method for said leather of a three-dimensional shape.

FIG. 5 An explanatory drawing showing the positions where a thread is put through a flat leather.

FIGS. 6 (a) and (b) are explanatory drawings showing the state of putting a thread into said leather.

FIG. 7 (a) is a plan view showing the state where said leather is wrung together, and (b) is a sectional view of the same.

FIGS. 8 (a) through (c) are explanatory drawings showing the state where said leather is wrung together with a thread.

FIG. 9 (a) is an explanatory drawing showing an example where an insulating material is attached to the side of recesses, and (b) is an explanatory drawing showing the state where said leather with the insulating material is soaked in a dye liquor.

FIG. 10 An explanatory drawing showing an alternative example where no insulating material is used.

FIG. 11 An explanatory drawing showing another alternative example where no insulating material is used.

FIG. 12 An explanatory drawing showing an alternative example where a heater is used.

FIG. 13 An explanatory drawing showing an alternative example where press dies are used.

### DESCRIPTION OF REFERENCE NUMERALS AND SYMBOLS

1 Recess

2 Protrusion

2a Protrusion-forming line

3 Side wall portion

4 Insulating material

5 Thread

5c Position

6 Dye liquor

7 Heater

8 Cooling layer

9a, 9b Press dies

10 Exothermic wire

11 Refrigerant pipe

20 Central portion

21 End portion

90 Recess region

A Leather of a three-dimensional shape

W1, W2 Stitch distances

### BEST MODE FOR CARRYING OUT THE INVENTION

Hereinafter, embodiments of the present invention are described in detail according to the attached drawings.

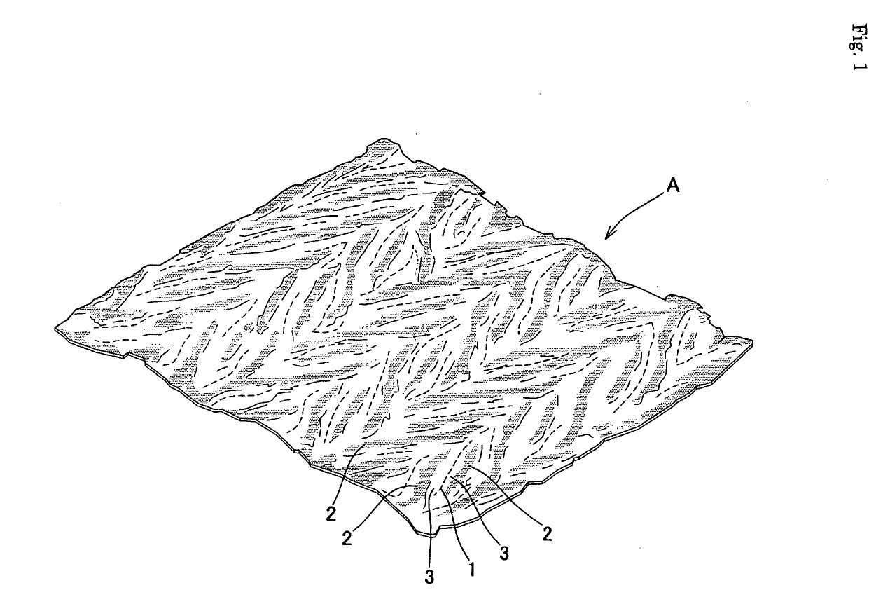

FIG. 1 is an explanatory drawing showing a representative embodiment of the leather of a three-dimensional shape as the present invention, where the reference numerals and symbols A, 1, 2 and 3 represent the leather, the recesses, the protrusions and the side wall portions, respectively.

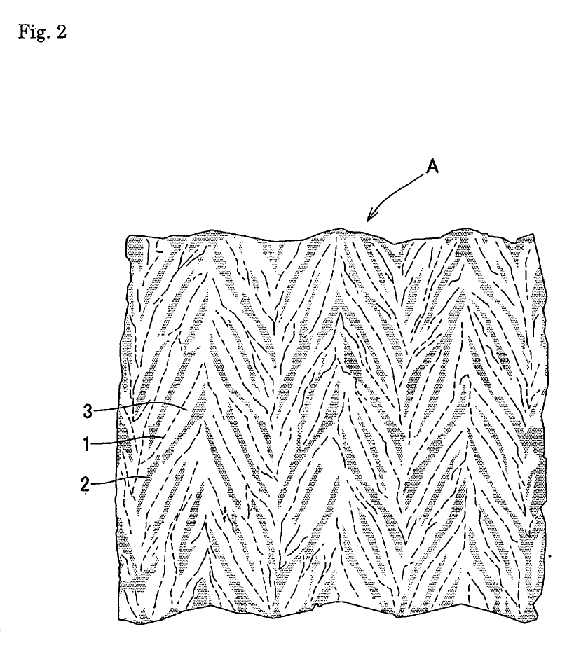

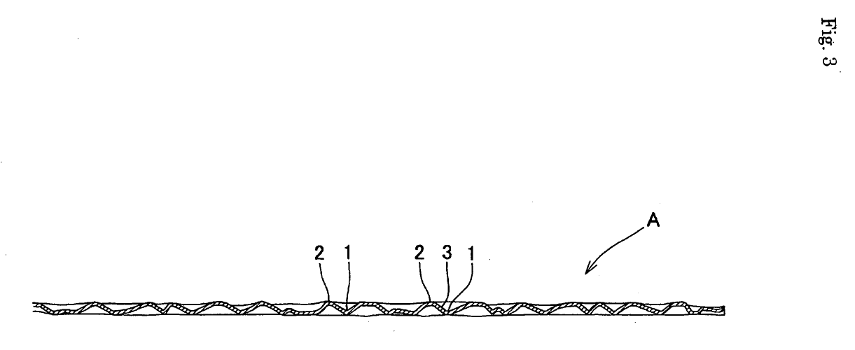

As shown in FIGS. 1 through 3, the leather of a three-dimensional shape (A) of this embodiment comprises of a motif with a combination of the protrusions (2) and the recesses (1), and characterized in that the three-dimensional shape is retained by deforming a flat leather into a three-dimensional shape having protrusions and recesses, heating at least a part of either or both of said protrusions (2) or recesses (1) to cure the heated parts, and causing the leather to retain a three-dimensional shape by said curing.

More specifically, remaining portions exclusive of the heated portions of said protrusions (2) and recesses (1) are insulated from the heat to cure only said heated portions so that the leather retains its three-dimensional shape by said cured portions and its flexibility by said insulating portions. In this embodiment, the protrusions (2) are subjected to the below-mentioned heat-curing treatment while other portions including the recesses (1) are insulated and thus, the protrusions (2) and recesses (1) are different in their flexibility.

The recesses (1) have a geometry swelling out to the back side of the leather and a plurality of them are provided on the whole leather depending on the design. Said recesses (1) are to be protected against dyeing in the below-mentioned dyeing process and thus insulated from the heat such that their contact with the dye liquor having the temperature mentioned below is avoided.

The protrusions (2) have a geometry swelling out to the front side of the leather and a plurality of them are provided in an alternation with said recesses (1) via side wall portions (3) in succession on the whole leather. Respective protrusions (2) are portions that contact the dye liquor in the heating process to be heated and cured, and their external surfaces around the top which is exposed to the outside when the leather is wrung together with threads are stained with the dye liquor to build color patterns.

In the leather of a three-dimensional shape (A) according to this embodiment, ridge lines of the respective protrusions (2) are arranged nearly parallel to each other at given intervals along a longitudinal direction and the respective ridge lines of a pair of the laterally aligned protrusions (2), (2) form a nearly [symbol] -shaped character or a nearly V-shaped character in a plane view. The ridge lines lengths of respective protrusions (2) are random, and it may be also allowed to arrange them randomly in a longitudinal direction. The crests of the protrusions (2) are stained with the dye liquor along these ridge lines to form said color patterns in the shape of a nearly [symbol] -shaped character or a nearly V-shaped character on the front side of the leather.

Actually as a matter of course, said process is by no means limited to the formation of color patterns using a dye liquor and the shaping of the patterns into e.g. said [symbol] -shaped characters, and it is also possible to produce other patterns including those having partially wrung portions with protrusions radially extending therefrom, completely random patterns, and the like.

Hereinafter, the processing method for the leather of a three-dimensional shape (A) of this embodiment is explained in detail.

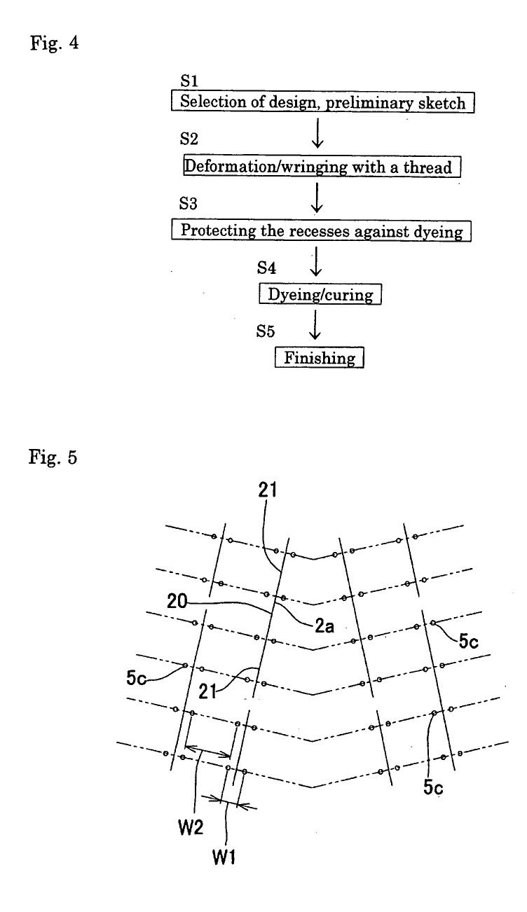

As shown in FIG. 4, the processing method for this embodiment comprises of the following steps:

(S1) First selecting a flat leather material to make a design and a preliminary sketch; (S2) Putting a linear sewing and wringing member such as a thread and a string into said leather (A), wringing the leather together to bring it into a state where a plurality of mountain-like protrusions (2) having a length lie in succession, thereby deforming the leather into a three-dimensional shape with said protrusions and recesses while the side wall portions (3) between the protrusions (2) and the recesses (1) are brought into an insulation state where they overlap each other; (S3) Securing the insulating material (4) closely to said recesses (1) for insulation and protection against dyeing; (S4) Soaking the whole leather (A) in a heating fluid (dye liquor) so that said protrusions (2) are brought into contact with said heating fluid and dyed/cured; and (S5) Finishing, so as to retain the three-dimensional shape by said curing.

There are a variety of criteria to determine what kind of leather is suitable for a three-dimensional design. It is necessary to take into consideration the selection of skin itself to be used, for example, fine-textured calf or rough-grained adult cattle hide, the determination of the thickness depending on properties of the skin to be used, the way of tanning, and the like. It is also allowed to use natural skins other than cattle hide, e.g. animal skins such as pig, goat, sheep, horse, birds, reptiles, fish, etc.

Here, a piece of skin may, for instance, undergo a combination of several tanning techniques. More specifically, both chrome tanning and vegetable tanning can be applied in a combination.

### (S1: Selection of Design, Preliminary Sketch)

Before deforming the leather into a three-dimensional shape, a perspective design thereof is determined and a preliminary sketch is then drawn on the leather in accordance with the envisaged design for specifying the positions where a thread is put into. In this embodiment, as shown in FIG. 5, lines are drawn in a nearly [symbol] -shaped character or a nearly V-shaped character along the positions where protrusions are folded to form a mountain-like shape. In particular, the directions and lengths thereof are determined to be random. The positions (5c) where a thread is put into are arranged zig-zag so as to intersect with these protrusion-forming lines (2a) at nearly right angles. Thereby, the leather can be wrung together more tightly and an improvement in the insulation of the side wall portions can be ensured.

Moreover, the positions (5c) where a thread is put into are defined such that the thread passes through preferably at or around the longitudinal ends (21), (21) of respective protrusions, more preferably, in addition other halfway points including the central portion (20) or the like, thereby forming the protrusions (2) without fail. Additionally, in this embodiment, the stitch distances are not made similar so as to sew the leather in several different spaces. More specifically, the stitch distance (W1) for forming the protrusion (2) is set to be narrower than the stitch distance (W2) for forming the recess (1) in order to put a thread into the leather with alternating different stitch distances.

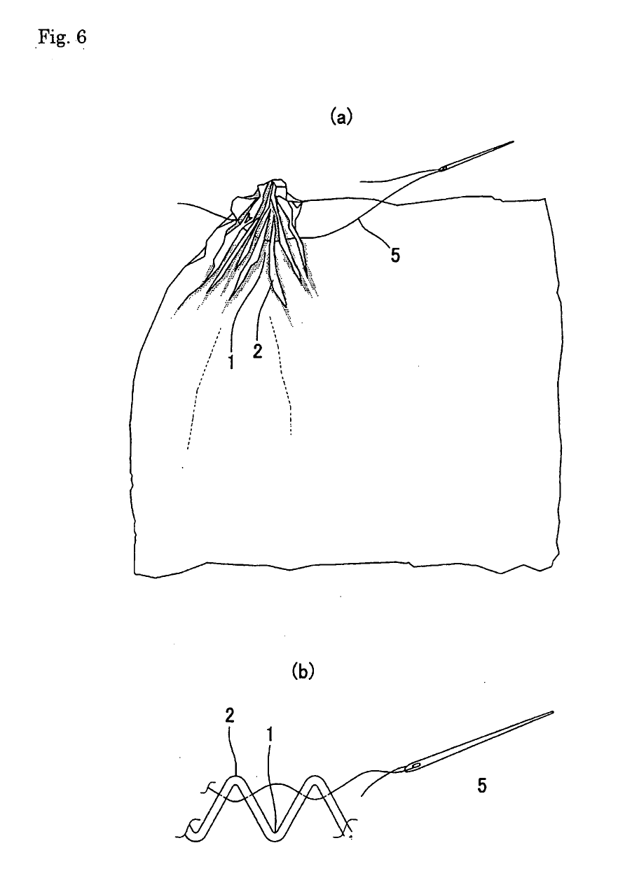

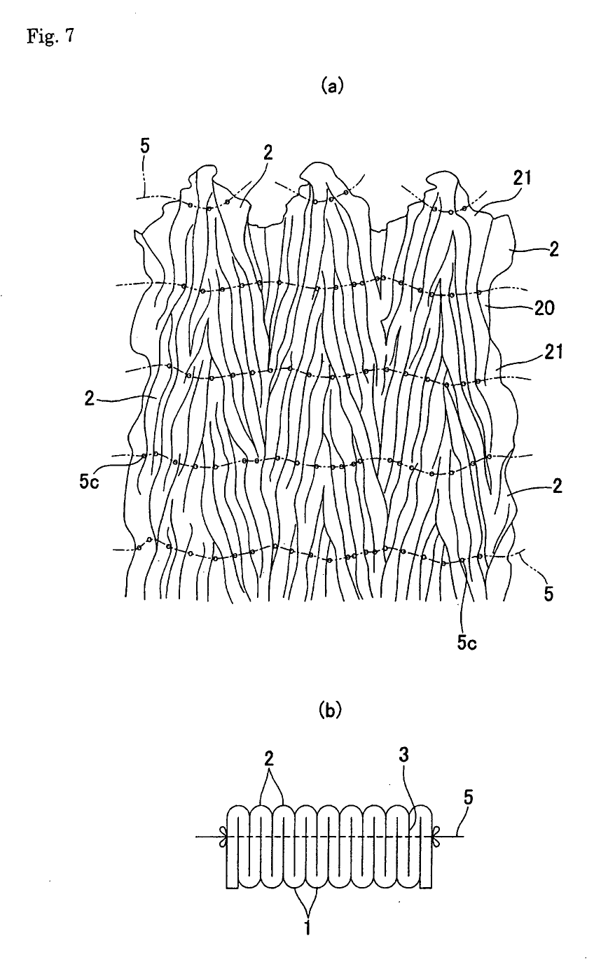

As shown in FIG. 6 (b), the thread (5) thus passes through the upper position rather than the midpoint in the protrusion height direction of said protrusions (2), and the exposed area, i.e. the area to be dyed by contact with the dye liquor, becomes smaller by a tighter overlapping of the protrusions (2) through wringing the leather together to be explained below, thereby sharp color patterns having a long slender shape can be obtained. By selecting as appropriate the height of positions to put a thread through, the thickness of the patterns to be dyed can be freely set so as to extend the scope of design, and said setting of the stitch distances, for example, allows to make the pattern of a portion of the protrusions (2) thin and sharp or that of another portion thick.

### (S2: Deformation/Wringing with a Thread)

Subsequently, as shown in FIG. 6 (a) and (b), while forming the mountain-like protrusions (2) and recesses (1) having a length in accordance with the preliminary sketch of said design, the thread (5) is put into the leather in a zig-zag motion to deform it into a three-dimensional shape with protrusions and recesses. More specifically, the thread is put through the leather which is partially folded like a mountain having a length on the ridge line to form the protrusion (2), then the leather is folded like a valley toward the back side to form the recess (1), and the same step is repeated up to the end portion so that the adjacent protrusions (2), (2) are sewn to overlap each other when wringing the leather together. The positions where a thread is put into are near the border between the dyed and non-dyed faces which are respectively stained and not stained in the post process.

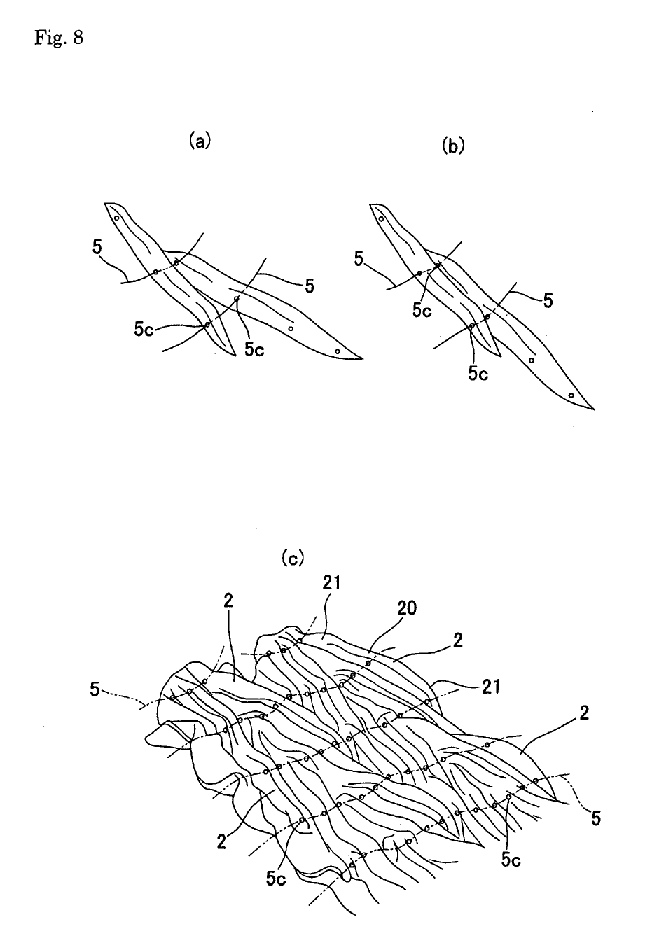

Separate threads are put through respective lines in the embodiment, but a single thread may, for example, be used for sewing several lines by repeated cycles of passing the thread from one end to the other end of the leather and putting the thread reversely from a hole of another line arranged on the side of the said other end. In this embodiment, as shown in FIG. 7 (a) and FIG. 8 (c), the threads pass through several lines, but as a matter of course, the line is allowed to be single only depending on the size and design.

Publicly known threads and needles can be used depending on the type of leather and etc. Examples of the applicable threads include: those composed of natural fibers derived from plants, such as silk, cotton and hemp, and animals; those composed of artificial fibers incorporating synthetic fibers, such as nylon, polyester, polyacryl, polyvinyl alcohol and polypropylene, semi-synthetic fibers and inorganic fibers; blended yarns, spun yarns, etc. Especially, for wringing the leather together, preferable threads are consisted of natural fibers, because they are shrunk when soaked in water and can thus tightly wring the leather together.

Sewing and wringing members other than a thread, such as a string and a wire, can be used, so long as they are linear. A string that is made by twisting or holding together one or more threads has a diameter larger than a thread. Sewing and wringing members to be used, such as a thread, a string and a wire, have preferably a thickness that does not damage the leather when putting into threads therethrough. When selecting sewing and wringing members such as a thread, etc., it is important to employ those are resistant to the heat of a heating means.

Examples of applicable needles include a flat pin, a twist pin, a leather pin, a reverse-twist pin, a cross pin, a wedge pin, a round pin, or the like.

Then, the threads (5) extending out of the ends of the leather are bound for wringing the leather together. As shown in FIGS. 7 and 8, as soon as the leather is deformed into a three-dimensional shape with protrusions and recesses, the protrusions (FIG. 8 (a)) arranged in a nearly [symbol] -shaped character or a nearly V-shaped character are bound firmly and parallel to each other (FIG. 8 (b)), and the side wall portions (3) between the protrusions (2) and the recesses (1) overlap each other to be brought into a insulated state where the heat of a heating fluid can not enter between the side wall portions when the whole leather is soaked in the heating fluid.

In this embodiment as a wringing proceeding, the insulating material (4) is attached to the side of recesses as explained below to wring the leather together such that the leather is bound together with said insulating material or only the insulating material is bound with another thread. There are also a variety of methods, for instance, wrapping the thread which is put through the end portion around a fixing member to wring the leather together and the like. Moreover, in this embodiment, each line is wrung with a single thread throughout the length thereof up to the end portion, but there exist other possible choices as appropriate to bind only suitable halfway points or the portions except the halfway points with a thread, and so on, depending on the design to be processed.

### (S3: Protecting the Recesses Against Dyeing)

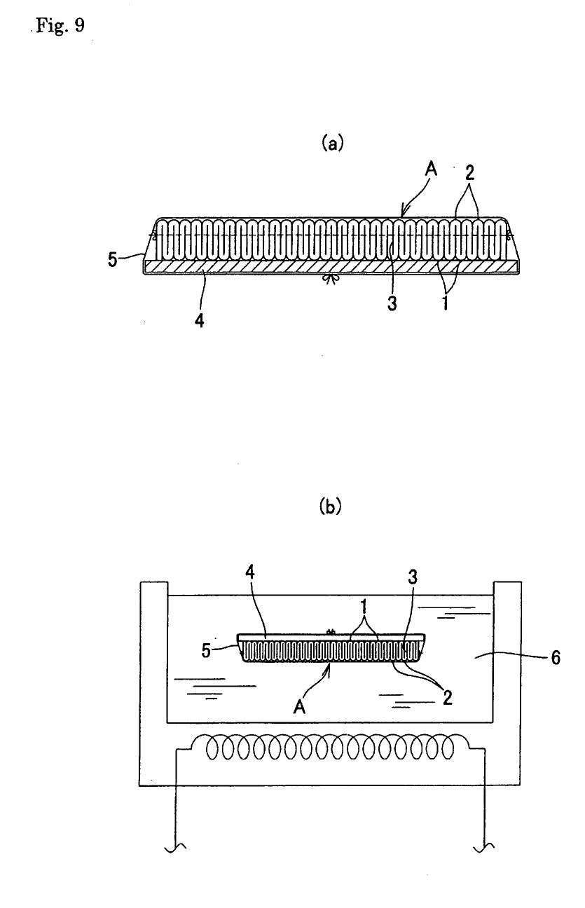

And as shown in FIG. 9 (a), the insulating material (4) which touches the recesses (1) from the back side of the leather is bound with e.g. thread (5) different from that used for wringing the leather together so as to prevent said recesses (1) from being brought into contact with a heating fluid. In this case, the leather may be wrung together by binding the insulating material (4), or said insulating material can be bound with the remaining thread after wringing of the leather together. For other techniques of installing the insulating material, any means can be employed, so long as the leather is not damaged.

Closely securing the insulating material (4) in that way allows even delicate protrusions and recesses to be insulated from the heat and it also functions as sealing for the side wall portions. Examples of the applicable insulating materials (4) which can be easily removed from the leather surface include members made of wood, synthetic resin, metal, etc. Metallic members having low thermal conductivity can prevent the recesses from being cured, and those having high thermal conductivity may also be preferably employed in terms of their function for inhibiting the dyeing, though they cause the recesses to be cured.

### (S4: Dyeing/Curing)

Next, as shown in FIG. 9 (b), the whole leather (A) wrung together is soaked with the insulating material (4) in the dye liquor (6) having the temperature required to cure said leather as a heating fluid in order to cure and dye the protrusions (2) which are exposed outside without being insulated and are contacted with the dye liquor (6). The temperature of the dye liquor is preferably 40° C. or more where the protrusions (2) of the leather can be cured, more preferably 45 through 85° C. in terms of avoiding the deterioration of the leather.

In this embodiment, the side wall portions (3) overlapped by wringing the leather together and the recesses (1) touching the insulating material (4) are respectively protected against contact with the dye liquor (6) and also insulated from the heat of said dye liquor so that only the protrusions (2) coming into contact with the dye liquor are dyed and cured.

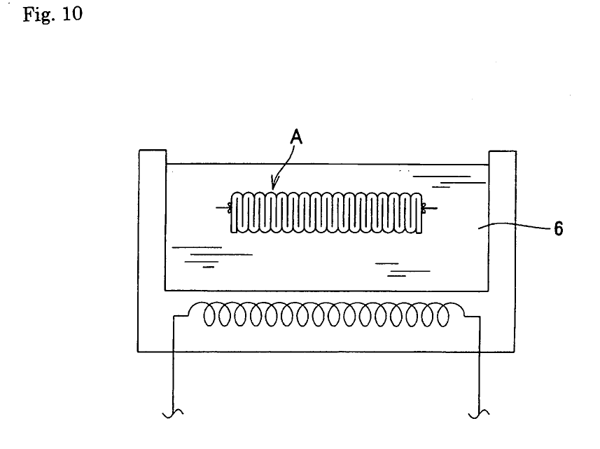

Thus, in this embodiment, the protrusions to be cured (the portion to be dyed) and the recesses not to be cured (the portion not to be dyed) are variegated using the insulating material (4), but it is also preferable to omit the insulating material (4) and cure not only the protrusions but also the recesses, as shown in FIG. 10, and according to said method, color patterns can be formed on both sides of the leather in the case of using the dye liquor (6) as a heating fluid. In this case, with regard to the above-mentioned stitch distance, for example, arranging alternate lines where a thread is put through the upper position rather than the midpoint in the protrusion height direction of the said protrusion (2) and a line where a thread is put through the lower position rather than the midpoint, i.e. nearer the recess, allows to closely overlap the protrusions and the recesses, respectively each other, for creating sharp color patterns with long slender cured portions on both sides of the leather.

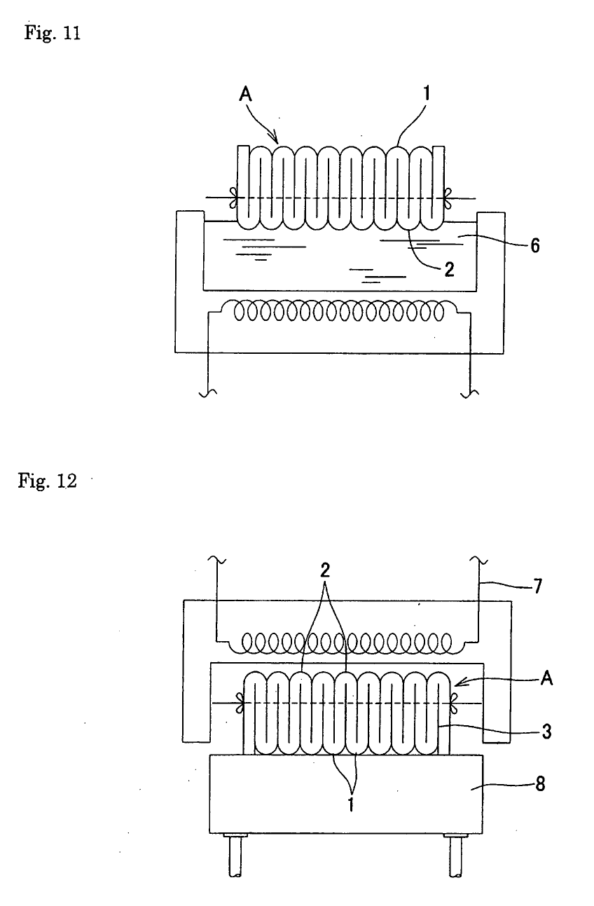

In addition, as shown in FIG. 11, soaking not the whole leather but at least the portion of protrusions (2) to be desirably heat-cured in the dye liquor (6) (heating fluid), with the recesses (1) kept outside of the liquid, enables the protrusions (1) to be prevented from being heat-cured while omitting said insulating material (4).

Moreover, it is also possible to place an insulating material with a masking function having an opening partially exposed to contact the heating fluid so that said insulating material touches the exposed surface of the protrusions (2) of the leather wrung together for dyeing/curing only a certain exposed portion of the protrusions (2) (the portion corresponding to the said opening), and it is also possible to similarly conduct the insulation of the recesses (1). Thereby, the scope of designs may be extended and the flexibility can be also enhanced.

In this embodiment, a dye liquor of a predetermined temperature is used as a heating fluid to dye the protrusions to be cured, but in the present invention, heating fluids other than dye liquor may be also employed, preferably those containing a medium which does not damage the leather (e.g. water). Through using a dye liquor as is the case of this embodiment, portions of the protrusions and recesses of the leather in contact with said dye liquor are cured and dyed and thus, there is an advantage that heat-curing and dyeing can be simultaneously conducted.

In this embodiment, the leather is heat-cured in the same process as dyeing, and it is thus necessary to control respective temperatures and times required for dyeing and heat-curing of the leather, depending on the leather type.

### (S5: Finishing)

Finally, the leather (A) is subjected to color fixing etc. as needed, and dried after removing the thread therefrom and washing with water. As a result, the leather retaining a three-dimensional shape with protrusions and recesses owing to the heat-cured protrusions (2) comes to completion.

Furthermore, there is another preferable embodiment where the shape retention is enhanced by putting a slight coat of synthetic resin, natural resin or a composite thereof applied or sprayed on the outer face of the leather which retains a three-dimensional shape by curing or only on the protrusions (2). Particularly, applying an elastic synthetic resin or a synthetic resin composition containing starch, silicon, etc. to the back side of the protrusions to such an extent that the difference in level between the said back side and the front side of the recesses is put out allows the protrusions and recesses to retain rich elasticity and as a result, the leather can be suitably used as a material for members, such as sofa covers and the like which are always subjected to friction with sitters.

Dyeing and heat-curing are simultaneously conducted by a dye liquor having temperatures sufficient for heat-curing in this processing method, but there is another possibility to perform a heat-curing treatment using heating fluids other than a dye liquor and carry out later a dyeing process.

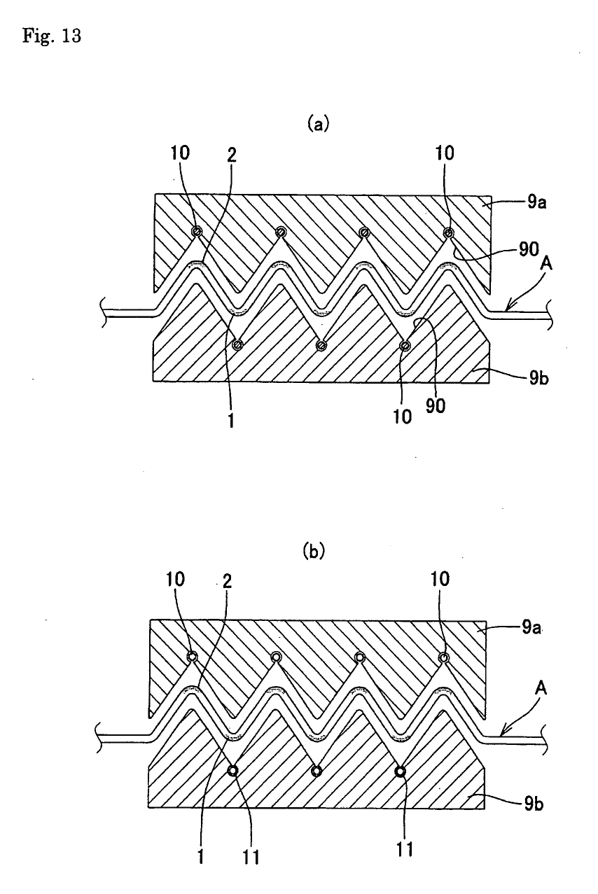

Hereinafter, another embodiment of the leather processing method as per the present invention is explained according to FIG. 12.

This embodiment is a method comprising of wringing the leather together by a linear sewing and wringing member such as a thread, a string, etc. to provide said leather with a three-dimensional shape having protrusions and recesses in similar proceedings as the method described above, then heat curing the leather with a heater (7) in place of the heating fluid. In the illustrated example, the protrusions (2) exposed outside are irradiated by heat of the heater, with a cooling layer (8) contacting the side of recesses (1) to be insulated from heat, so that said protrusions (2) are heat-cured.

Thus, in a manner similar to the above-mentioned method of using a heating fluid, it is possible to produce the leather of a three-dimensional shape retaining stretchability as a whole, where only the protrusions (2) are heat-cured so as to serve retaining the three-dimensional shape, while the side wall portions (3) and the recesses (1) preserve the flexibility inherent in the leather. In place of the heater, a hot plate, etc. having a given temperature for curing the leather may be pressed against the protrusions (2) etc.

Here, unlike the case where the leather is soaked completely in the heating fluid, an insulating material such as the cooling layer (8) is not absolutely required, and it is possible to heat only the protrusions (2) by the heater without such insulating material. Additionally, in the case where only the protrusions (2) are dyed after the processing, starch (nori) or wax is applied to the places to be protected against dyeing such as the recesses (1), the side wall portions, etc. to prevent penetration of the dye liquor, and the leather can be then soaked and treated in the dye liquor.

Hereinafter, another embodiment of the leather processing method as per the present invention is described according to FIG. 13.

This embodiment is a method comprising of, instead of wringing the leather (A) together with a thread or a string as shown in the above-mentioned example, applying a pressure so as to deform the leather into a shape of recesses and protrusions from both sides by using a pair of press dies (9a), (9b) with protrusions and recesses, having an exothermic wire (10) and a refrigerant pipe (11) in place thereof, and heat-curing at least portions of either or both of said deformed protrusions (2) and recesses (1).

For example, as shown in FIG. 13 (a), placing an exothermic wire (10) on the recess regions (90) and (90), respectively, of the press dies (9a) and (9b) corresponding to the protrusions (2) and the recesses (1) enables to yield the leather of a three-dimensional shape where the protrusions (2) and recesses (1) are cured. On the other hand, as shown in FIG. 13 (b), providing a refrigerant pipe (11) for the recess region (90) of the press die (9b) corresponding to the recesses (1) allows obtaining the leather of a three-dimensional shape where only the protrusions (2) are cured. The press dies may be cooled or heated in advance.

Unlike a conventional technique of keeping the shape retention by applying pressure, these methods preserve the shape retention by heat-curing and thus, it is possible to minimize the pressure required and prevent the leather to be damaged by pressure applied.

The embodiments of the present invention have been described in detail, and the present invention will be by no means confined to these embodiments and may be employed in various embodiments, such as those applying a heat-curing treatment on a portion of several protrusions, heat-curing of the portions in a combination of protrusions and recesses, and the like, without departing from the scope of the invention.

### INDUSTRIAL APPLICABILITY

The leather of a three-dimensional shape of the present invention is preferably available for overall leather goods, for example: furniture such as sofas, chairs and clothes; interior materials for vehicles, ships and aircrafts including steering wheels and seats; consumer goods including bags, sacks, shoes, gloves, apparel and the miscellaneous goods; stretchable materials such as cushion materials; and interior decorative materials, etc. In addition, the leather with a three-dimensional shape of the present invention has low environmental impact when disposed as well as moisture-absorption and retention characteristics and thus, can be processed into compost and soil, finding an application as disposable commodities, such as a vessel for nursery plant, a vessel for plant cultivation, a string for binding plants etc., an insulation sheet for trees, a sheet for preventing dispersion of manure-soil and a sheet convertible into manure. Moreover, combining the leather of a three-dimensional shape of the present invention with wood, glass, stone, plastics and metal enables to diversify industrial products which were difficult to manufacture using only leather materials, and the leather concerned is widely applicable to parts for e.g. vehicles, ships, aircrafts, machines, electrical appliances (mobile phones and personal computes etc.), and the like.

1. A method of leather processing comprising the steps of deforming a flat leather into a three-dimensional shape having protrusions and recesses, heating at least a part of either or both of said protrusions or recesses to cure the heated parts, and causing the leather to retain a three-dimensional shape by said curing.

2. The method of leather processing according to claim 1, comprising the step of insulating the remaining parts exclusive of the heated parts of said protrusions and recesses.

3. The method of leather processing according to claim 1, wherein a linear sewing and wringing member such as a thread or a string is put into a flat leather to wring the leather together so as to bring the leather into a state where a plurality of mountain-like protrusions having a length lie in succession, thereby deforming the leather into a three-dimensional shape having said protrusions and recesses.

4. The method of leather processing according to claim 3, wherein said sewing and wringing member is put through said protrusions at both ends of their lengthwise directions or neighborhood thereof

5. The method of leather processing according to claim 3, wherein said sewing and wringing member is put through said protrusions at both ends of their lengthwise directions or neighborhood thereof and intermediary portions thereof.

6. The method of leather processing according to claim 3, wherein said sewing and wringing member is put through said protrusions at an upper position rather than the intermediary position of their protruding height directions.

7. The method of leather processing according to claim 3, wherein the leather is wrung together so as to bring the leather into a state where a plurality of mountain-like protrusions having a length lie in succession, thereby overlapping side wall portions between the protrusions and recesses each other in order to bring them into an insulating state.

8. The method of leather processing according to claim 1, wherein either of said protrusions or recesses are insulated by externally fitting an insulating material closely onto them while the other protrusions or recesses are heat-cured by a heating means.

9. The method of leather processing according to claim 1, wherein a heater is used as said heating means.

10. The method of leather processing according to claim 1, wherein a heating fluid is used as said heating means in which at least heated portions are soaked.

11. A method of leather processing comprising the steps of putting a linear sewing and wringing member such as a thread or a string into a flat leather to wring the leather together so as to bring the leather into a state where a plurality of mountain-like protrusions having a length lie in succession to thereby deform the leather into a three-dimensional shape having protrusions and recesses, while overlapping side wall portions between the protrusions and recesses in order to bring them into an insulating state, soaking the whole leather in a heating fluid to cure the protrusions and recesses, and retaining a three-dimensional shape by said curing.

12. A method of leather processing comprising the steps of putting a linear sewing and wringing member such as a thread or a string into a flat leather to wring the leather together so as to bring the leather into a state where a plurality of mountain-like protrusions having a length lie in succession to thereby deform the leather into a three-dimensional shape having protrusions and recesses, and overlapping side wall portions between the protrusions and recesses in order to bring them into an insulating state, insulating either of said protrusions or recesses by externally fitting an insulating material closely onto them, soaking the whole leather in a heating fluid to cure the other of said protrusions or recesses, and causing the leather to retain a three-dimensional shape by said curing.

13. The method of leather processing according to claim 10, wherein a dye liquor at a given temperature is used as said heating fluid.

14. The method of leather processing according to claim 1, wherein resin or resin compound is attached to the outer surface of the leather retaining a three-dimensional shape by curing.

15. The method of leather processing according to claim 1, wherein ridge lines of respective protrusions are arranged parallel to each other.

16. The method of leather processing according to claim 1, wherein the lengths of ridge lines of respective protrusions and their positions in the lengthwise direction are random to each other in a plane view.

17. The method of leather processing according to claim 1, wherein a plurality of pairs of protrusions of which ridge lines are arranged in a nearly [symbol] -shaped character or a nearly V-shaped character in a plane view are provided in a given distance laterally and longitudinally.

18. A leather of a three-dimensional shape, wherein the three-dimensional shape is retained by deforming a flat leather into a three-dimensional shape having protrusions and recesses, heating at least a part of either or both of said protrusions (2) or recesses (1) to cure the heated parts, and causing the leather to retain a three-dimensional shape by said curing.

19. The leather of a three-dimensional shape according to claim 18, formed by insulating the remaining parts exclusive of the parts to be heated of said protrusions and recesses to cure said heated parts only.

20. A leather of a three-dimensional shape, wherein the three-dimensional shape is retained by putting a linear sewing and wringing member such as a thread or a string into a flat leather to wring the leather together so as to bring the leather into a state where a plurality of mountain-like protrusions having a length lie in succession to thereby deform the leather into a three-dimensional shape having protrusions and recesses, while overlapping side wall portions between the protrusions and recesses in order to bring them into an insulating state, soaking the whole leather in a heating fluid to cure the protrusions and recesses, and retaining a three-dimensional shape by said curing.

21. A leather of a three-dimensional shape, wherein the three-dimensional shape is retained by putting a linear sewing and wringing member such as a thread or a string into a flat leather to wring the leather together so as to bring the leather into a state where a plurality of mountain-like protrusions having a length lie in succession to thereby deform the leather into a three-dimensional shape having protrusions and recesses, and overlapping side wall portions between the protrusions and recesses in order to bring them into an insulating state, insulating either of said protrusions or recesses by externally fitting an insulating material closely onto them, soaking the whole leather in a heating fluid to cure the other of said protrusions or recesses, and causing the leather to retain a three-dimensional shape by said curing.

22. The leather of a three-dimensional shape according to claim 18, wherein ridge lines of respective protrusions of the leather are arranged parallel to each other.

23. The leather of a three-dimensional shape according to claim 18, wherein the lengths of ridge lines of respective protrusions and their positions in the lengthwise direction are random to each other in a plane view.

24. The leather of a three-dimensional shape according to claim 18, wherein a plurality of pairs of protrusions of which ridge lines are arranged in a nearly [symbol] -shaped character or a nearly V-shaped character in a plane view are provided in a given distance laterally and longitudinally.
